(19) United States
(12) Patent Application Publication
(10) Pub. No.: US 2016/0071173 A1
(43) Pub. Date: Mar. 10, 2016

(54) System and methods that capture, distribute, and measure shared business opportunities

(71) Applicant: GRANT PATRICK HENDERSON, ANAHEIM, CA (US)

(72) Inventor: GRANT PATRICK HENDERSON, LAS VEGAS, NV (US)

(73) Assignee: GRANT PATRICK HENDERSON, ANAHEIM, CA (US)

(21) Appl. No.: 14/846,980

(22) Filed: Sep. 7, 2015

Related U.S. Application Data
(60) Provisional application No. 62/047,247, filed on Sep. 8, 2014.

(51) Int. Cl. G06Q 30/06

(52) U.S. Cl. CPC G06Q 30/0601

(57) ABSTRACT

A computerized system and methods that permit an entity to capture the details of a business opportunity and then share the business opportunity to another entity and track the performance of all entities with regard to the business opportunity.

### CROSS-REFERENCE TO RELATED APPLICATIONS

Provisional application No. 62/047,257, filed on Sep. 8, 2014.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### CLAIM OF PRIORITY

This patent application claims the benefit of priority, under 35 U.S.C. Section 119(e), to U.S. Provisional Patent Application Ser. No. 62/047,257, entitled “System and methods that capture, distribute and measure shared business opportunities,” filed on Sep. 8, 2014 to Henderson, which is hereby incorporated by reference herein in its entirety.

### TECHNICAL FIELD

This invention relates to the fields of marketing, computer science and generally to a database of records compiled from entities with common links and methods that manage, manipulate, and utilize these records.

### BACKGROUND OF THE INVENTION

In the course of doing business, businesses and their representatives (e.g., employees, officeholders, etc.) may encounter business opportunities where they are unable to directly provide products and/or services. Rather than pass on these opportunities, the business may recommend some other business or pass on the potential customers information to some other business. These practices are a form of business opportunity sharing and are often described as business recommendations or business referrals.

Business referral or affiliate schemes usually require a business first to create a program with preset conditions (e.g., receive 10% referral fee). This requires each business to first consider, design, and execute a program before new business can be accepted.

In some cases, businesses have been created around the concept of business referrals (e.g., Business Network lnternational.TM. and LeTip.TM.), however, they further restrict the practice of sharing business opportunities by enforcing requirements for their members to share equal numbers of business opportunities (transaction counting) and on a regular basis. Business relationships are rarely of equal value as businesses vary in physical and financial size as do the business opportunities they engage in. More importantly, business relationship frequently extend beyond single communities.

Existing systems for sharing business opportunities are also simplistic and merely count transactions or key dates (e.g., ReferralKey™). They rarely consider the value of shared business opportunities (e.g., dollars per month) or the outcomes of the act of sharing (e.g., Did the act of sharing a business opportunity lead to a successful transaction? Would that outcome affect future outcomes?)

What is needed is a way of sharing business opportunities and measuring the outcome and performance of each shared business opportunity at different stages in a business transaction to help determine whether a business should share a business opportunity with a specific business in the future and/or whether a business should accept a business opportunity from a particular source business in the future. The outcomes of past performance can be used to assess the likely outcomes of future performance.

### SUMMARY OF THE INVENTION

The present invention teaches a computerized business opportunity sharing system and methods that permit an entity to capture the details of a business opportunity and then share the business opportunity to another entity and measure the outcomes of the business opportunity with regard to each participant and a view to improving business performance of subsequent business opportunities.

### BRIEF DESCRIPTION OF THE DRAWINGS

FIG. 1 illustrates a system architecture, including the business opportunity sharing system, its servers, database, methods, a computer network by which communication will occur, and the remote terminal of a User, Person or representative of Business Entity.

FIG. 2 illustrates a computerized method for capturing a business opportunity.

FIG. 3 illustrates a computerized method for sharing a business opportunity with a single entity.

FIG. 4 illustrates a computerized method for sharing a business opportunity with a plurality of entities.

FIG. 5 illustrates a computerized method for offering and negotiating a business opportunity with a single entity.

FIG. 6 illustrates a computerized method for offering and negotiating a business opportunity with a plurality of entities.

FIG. 7 illustrates a computerized method for measuring the performance of a business opportunity.

FIG. 8 illustrates a computerized method for canceling a shared business opportunity.

### DETAILED DESCRIPTION OF THE INVENTION

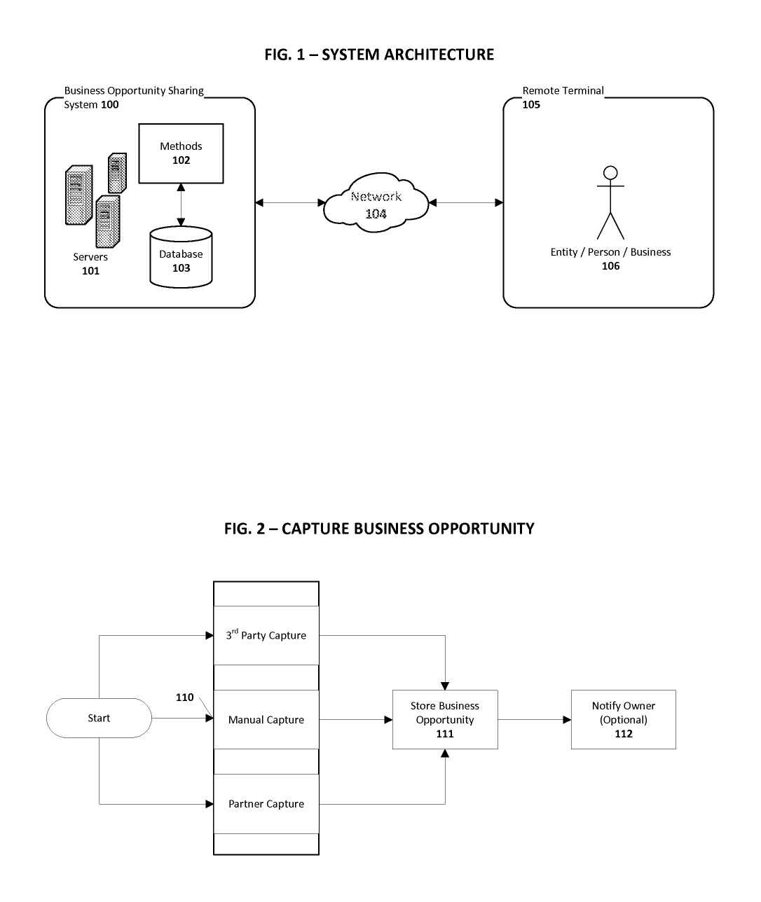

A block diagram of the business opportunity sharing system is shown in FIG. 1.

The business opportunity sharing system 100 (“System”) comprises:

a database system 103 that stores information about each entity, the relationships between entities, communication between entities and transactions performed between entities;

methods 102 for storing and manipulating information involving entity relationships, communication and transactions;

computer servers 101 (including server farms, distributed computers, and/or other scalable server technologies) and physical network connections 104 (including ethernet, wifi, and/or other electronic data networks) that facilitate electronic communication from the business opportunity sharing system 100 to any remote terminal 105 (including, but not limited to, personal computers, server computers, mobile devices, tablets, and/or other input/output devices).

The methods 102 are executed by a plurality of data processors and processor memory within the computer servers 104 of the business networking system 100 that manipulate data stored in the database system 103 according to the rules of the method.

The methods 102 of the business networking system 100 are accessed and initiated via HyperText Markup Language (HTML), application programming interfaces (API), and/or other network and communications technologies by an operator that may a Person, Business or any other Entity including automatic methods 106.

The business opportunity sharing methods comprise:

Capture a Business Opportunity

FIG. 2 shows a computerized method for capturing a business opportunity 110-112. The entity capturing the business opportunity is known as the Owner.

The Business Opportunity is captured by manual user input or automated methods from sources such as users, end-users, partners, members of the public and other 3rd parties 110. The Business Opportunity includes Identifying Information about the potential Customer (including, but not limited to, name, address, telephone, email, and other fields) and Non-Identifying Information that describes the Business Opportunity (including, but not limited to, a description of the opportunity, budget, photographs, video, audio, or other supporting information).

The Business Opportunity is then stored in a database for later retrieval and manipulation 111. The System optionally notifies the Owner when a Business Opportunity is captured 112.

Share a Business Opportunity with a Single Entity

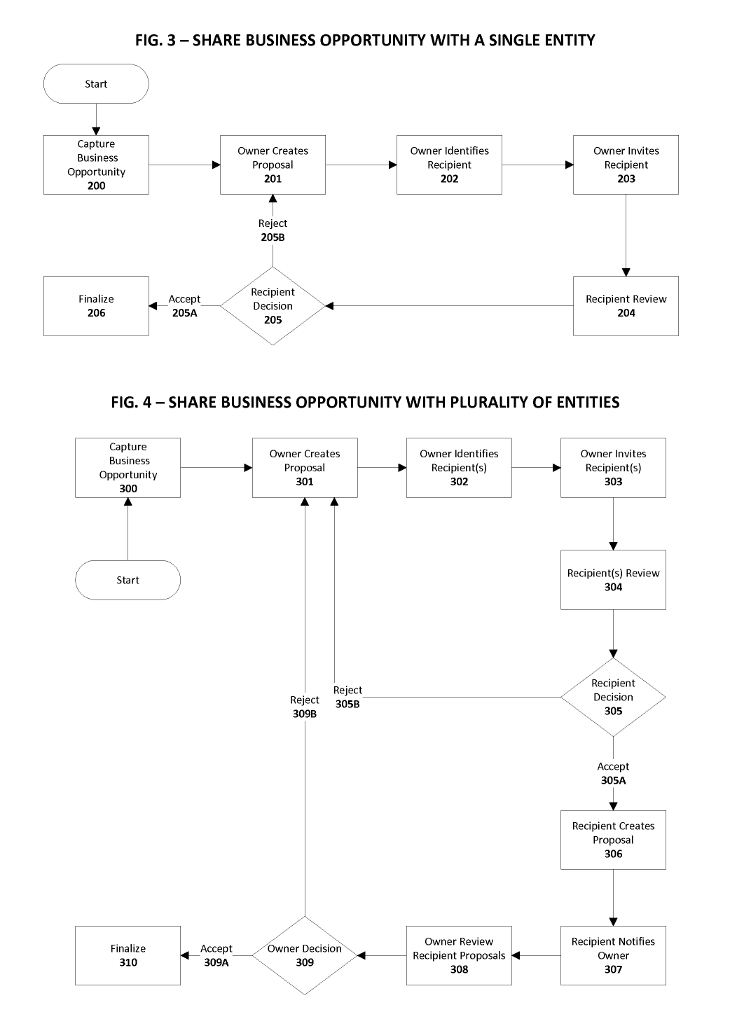

FIG. 3 shows a computerized method for sharing a business opportunity with a single entity 200-206.

A Business Opportunity is first captured 200 & FIG. 2 by a party designated as the Owner of the business opportunity.

The Owner defines a Proposal 201 that includes, but is not limited to, the Business Opportunity, terms of sale, contract, expiry, frequency of updates, requirements of updates, expiry of updates, and automatic cancelation.

The Owner identifies a Recipient 202 using methods including, but not limited to, address book, directory, business connection, or social profile.

The System notifies the Recipient on behalf of the Owner 203 using communication methods including, but not limited to, email, SMS, telephone, business network, or social network.

The Recipient reviews the invitation 204 including the Proposal 201 and the Business Opportunity Non-Identifying Information. The System withholds Business Opportunity Identifying Information from the Recipient.

The Recipient chooses 205 to either Accept 205A or Reject 205B the Proposal. If Rejected 205B, the Owner may attempt to share the Business Opportunity with other entities or cancel it entirely. If Accepted 205A, the Proposal is Finalized 206 and the Business Opportunity Identifying Information is disclosed to the Recipient.

Share a Business Opportunity with a Plurality of Entities

FIG. 4 shows a computerized method for sharing a business opportunity with a plurality of entities 300-310.

A Business Opportunity is first captured 300 & FIG. 2 by a party designated as the Owner of the business opportunity.

The Owner defines an optional Proposal 301 including the terms of sale, contract, expiry, frequency of updates, requirements of updates, expiry of updates, and automatic cancelation. If the Proposal is not provided by the Owner, there is an expectation that each Recipient will offer a Proposal containing similar information 306.

The Owner identifies a plurality of Recipients 302 using methods including, but not limited to, address book, directory, business connection, or social profile.

The System notifies all identified Recipients on behalf of the Owner 303 using communication methods including, but not limited to, email, SMS, telephone, business network, or social network.

Each Recipient reviews their invitation 304 including the Proposal 301 and the Business Opportunity Non-Identifying Information. The System withholds the Business Opportunity Identifying Information from each Recipient.

Each Recipient chooses 305 to either Accept 305A or Reject 305B the Proposal. If Rejected 305B, the Owner may share the Business Opportunity with other parties or cancel it entirely. If Accepted 305A, the Recipient creates a Proposal 306 that may be the same as the Owners proposal 301 or an entirely new Proposal.

The System notifies the Owner of each Recipient Proposal 307 using communication methods including, but not limited to, email, SMS, telephone, business network, or social network. The method used may be different to the original method used by the Owner 303.

The Owner reviews each Recipient Proposal 308. The Owner review may occur as each Proposal is received, as a group of Proposals or in any combination the Owner prefers.

The Owner chooses 309 to Accept one or more Proposals 309A or Reject one or more Proposals 309B until no Proposals remain.

Each Accepted Proposal is Finalized 310 and the Business Opportunity Identifying Information is disclosed to each Accepted Recipient.

Offer and Negotiate a Business Opportunity with a Single Entity

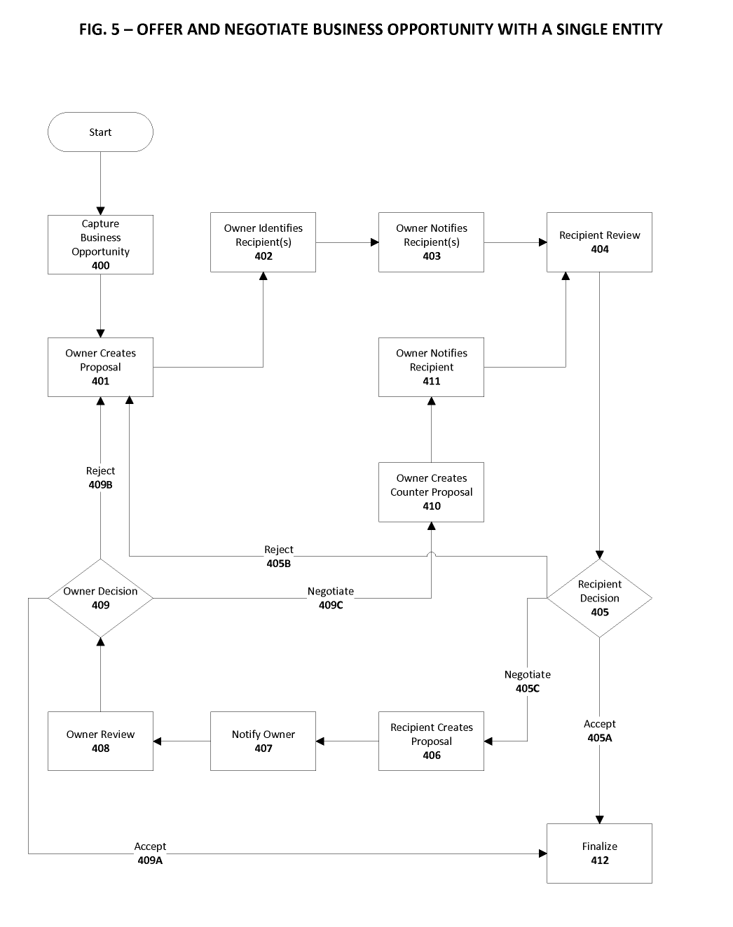

FIG. 5 shows a method for offering and negotiating a business opportunity with a single entity 400-412.

A Business Opportunity is first captured 400 & FIG. 2 by a party designated as the Owner of the business opportunity.

The Owner defines an optional Proposal 401 including the terms of sale, contract, expiry, frequency of updates, requirements of updates, expiry of updates, and automatic cancelation. If the Proposal is not provided by the Owner, there is an expectation that the Recipient will offer a Proposal containing similar information 406.

The Owner identifies a Recipient 402 using methods including, but not limited to, address book, directory, business connection, or social profile.

The System notifies the Recipient on behalf of the Owner 403 using communication methods including, but not limited to, email, SMS, telephone, business network, or social network.

The Recipient reviews their invitation 404 including the optional Proposal 401 and the Business Opportunity Non-Identifying Information. The Business Opportunity Identifying Information is withheld from the Recipient.

The Recipient chooses 405 to either Accept 405A or Reject 405B or Negotiate 405C the Proposal. If Rejected 405B, the Owner may attempt to share the Business Opportunity with other parties or cancel it entirely. If Accepted 405A, the Proposal is Finalized 412 and the Business Opportunity Identifying Information is disclosed to the Recipient. If Negotiated 405C, the Recipient creates a Proposal 406 that may be based on the Owner Proposal or an entirely new Proposal.

The Recipient notifies the Owner of their Proposal 407 using communication methods including, but not limited to, email, SMS, telephone, business network, or social network. The method used may be different to the original method used by the Owner 403.

The Owner reviews each Recipient Proposal 408. The Owner review may occur as each Proposal is received, as a group of Proposals or in any combination the Owner prefers.

The Owner chooses 409 to either Accept 409A or Reject 409B or Negotiate 409C the Proposal. If Rejected 409B, the Owner may attempt to share the Business Opportunity with other parties or cancel it entirely. If Accepted 409A, the Proposal is Finalized 412 and the Business Opportunity Identifying Information is disclosed to the Recipient. If Negotiated 409C, the Owner creates a Proposal 410 that may be based on any previous Owner or Recipient Proposal or an entirely new Proposal and notifies the Recipient of the new Proposal 411 using communication methods including, but not limited to, email, SMS, telephone, business network, or social network. The method used may be different to all previous methods used 403 & 407.

Offer and Negotiate a Business Opportunity with a Plurality of Entities

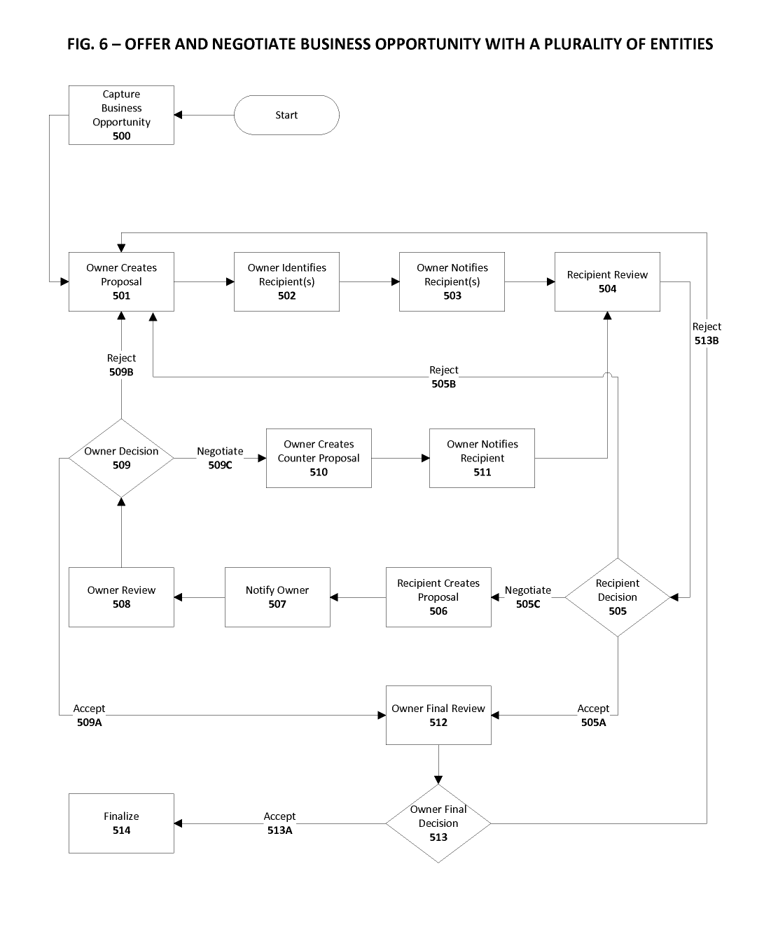

FIG. 6 shows a method for offering and negotiating a business opportunity with a single entity 500-514.

A Business Opportunity is first captured 500 & FIG. 2 by a party designated as the Owner of the business opportunity.

The Owner defines an optional Proposal 501 including the terms of sale, contract, expiry, frequency of updates, requirements of updates, expiry of updates, and automatic cancelation. If the Proposal is not provided by the Owner, there is an expectation that the Recipient will offer a Proposal containing similar information 506.

The Owner identifies a plurality of Recipients 502 using methods including, but not limited to, address book, directory, business connection, or social profile.

The System notifies all identified Recipients on behalf of the Owner 503 using communication methods including, but not limited to, email, SMS, telephone, business network, or social network.

Each Recipient reviews their invitation 504 including the optional Proposal 501 and the Business Opportunity Non-Identifying Information. The Business Opportunity Identifying Information is withheld from the Recipient.

Each Recipient chooses 505 to either Accept 505A or Reject 5058 or Negotiate 505C the Proposal. If Rejected 5058, the Owner may attempt to share the Business Opportunity with other parties or cancel it entirely. If Accepted 505A, the Proposal is returned the Owner for Final Review 512. If Negotiated 505C, the Recipient creates a Proposal 506 that may be based on the Owner Proposal or an entirely new Proposal.

The System notifies the Owner of their Recipient Proposal on behalf of the Owner 507 using communication methods including, but not limited to, email, SMS, telephone, business network, or social network. The method may be different to the original method used by the Owner 503.

The Owner reviews each Recipient Proposal 508. The Owner review may occur as each Proposal is received, as a group of Proposals or in any combination the Owner prefers.

The Owner chooses 509 to either Accept 509A or Reject 509B or Negotiate 509C each Recipient Proposal. If Rejected 509B, the Owner may attempt to share the Business Opportunity with other parties or cancel it entirely. If Accepted 509A, the Proposal is queued for Final Review 512. If Negotiated 509C, the Owner creates a Proposal 510 that may be based on any previous Owner or Recipient Proposal or an entirely new Proposal and notifies the Recipient of the new Proposal 511 using communication methods including, but not limited to, email, SMS, telephone, business network, or social network. The method may be different to all previous methods used 503 & 507.

The Owner performs a Final Review 512 to makes a Final Decision 513 and chooses to Accept one or more Proposals 513A or Reject one or more Proposals 513B. If Rejected 513B, the Owner may attempt to share the Business Opportunity with other parties or cancel it entirely. If Accepted 513A, each Accepted Proposal is Finalized 514 and the Business Opportunity Identifying Information is disclosed to each Accepted Recipient.

Measure the Performance of a Shared Business Opportunity

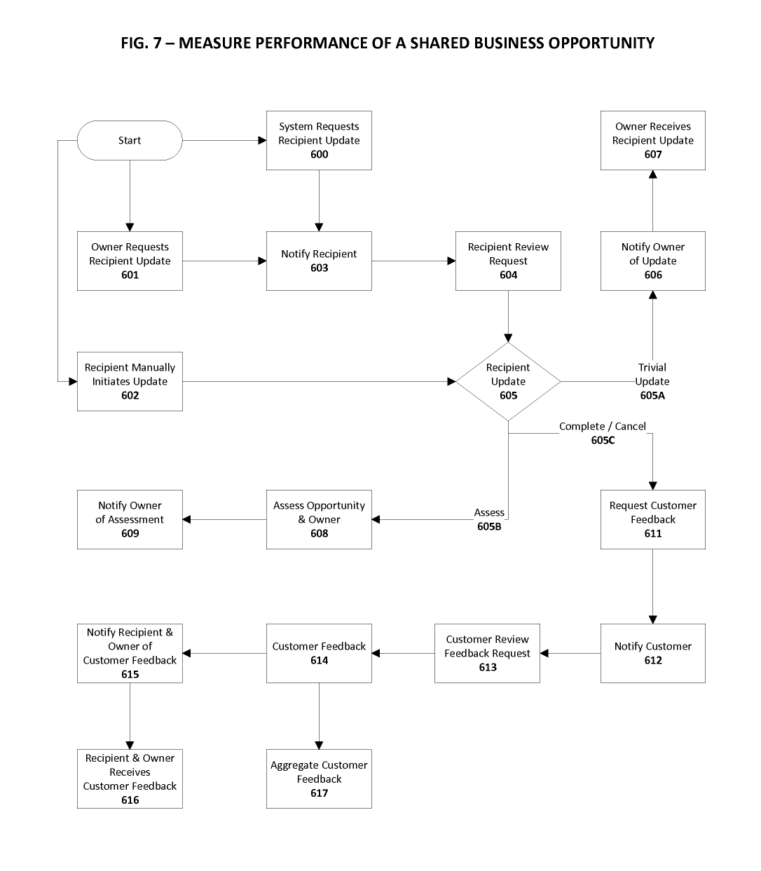

FIG. 7 shows a method for measuring the performance of a business opportunity 600-617 after it is Finalized in other methods.

Business Opportunities that are Finalized and shared as Accepted Proposals (FIG. 3 206, FIG. 4 310, FIG. 5 412, and FIG. 6 514), are monitored by the System for specific performance of the Owner and Recipient respectively. Performance of the Owner can be measured by an Assessment of the business opportunity shared, as assessed by the Recipient. Performance of the Recipient can be measured by Customer Feedback of the business opportunity assessed by the Customer and made available to both the Recipient and the Owner. Aggregated scores, using common statistical methods (e.g., mean, median, average, standardization, etc.), can be offered to potential other Owners and Recipients for future business sharing opportunities.

There are three ways to initiate updates on an Accepted Proposal for a Business Opportunity. The System may automatically request Updates from a Recipient 600. The Owner may manually request an Update via the System from a Recipient 601. The Recipient may manually initiate an Update to the Owner 602 using the System.

The Update contains status or other information to support the Update to the Owner. In the event that the Proposal is cancelled, the Update information can be used to transform the original Proposal into any subsequent Proposals (e.g., by narrowing or widening the scope of a Proposal, the terms, etc.)

Where the System or Owner requests an update 600 & 601, the System notifies the Owner of the Update 603 using communication methods including, but not limited to, email, SMS, telephone, business network, or social network.

The Recipient reviews the Update Request either in the notification itself or via a data entry form 604.

The Recipient chooses what type of Update to provide 605, including Trivial Updates 605A such as Customer Contacted, Delayed, Quotation, etc. that do not affect the operation of the System, or non-trivial Updates such as Assessed 605B, Completed 605C and Cancelled 605C that directly affect the operation of the System.

In the event of a Trivial Update 605A, the System notifies the Owner 606 using communication methods including, but not limited to, email, SMS, telephone, business network, or social network, and the Owner receives the details of the Update 607.

In the event of a non-trivial Update of Assess 605B, the Recipient enters information that Assesses the business opportunity 608 and the Owner is notified of the Recipient's Assessment 609. The Assessment may include textual feedback, numerical scores or ratings, or information that might also have been included in any Update (e.g., quality of the opportunity, reliability of information provided, etc.)

In the event of a non-trivial Update of Complete or Canceled 605C, the Recipient must first complete the Assessment sub-method (605B, 608, 609) to ensure that the Owner is correctly informed as to the merit of the business opportunity they shared. If the Assessment is completed, the System creates a Feedback Request for the Customer 611 and notifies the Customer of that request 612. The Customer Feedback can be requested when Completed or Canceled and may include manual intervention where the owner of the System contacts the Customer directly for Feedback input into the System.

The Customer reviews the Feedback Request 613 and provides Feedback 614. The Customer Feedback can be aggregated to measure the performance of the Recipient 617 for future business opportunity sharing.

The Customer Feedback captured 614, triggers a notification by the System to the Owner and the Recipient 615. The Owner and the Recipient can each review the Customer Feedback 616 as it may form the basis for future shared business opportunities.

Cancel a Shared Business Opportunity

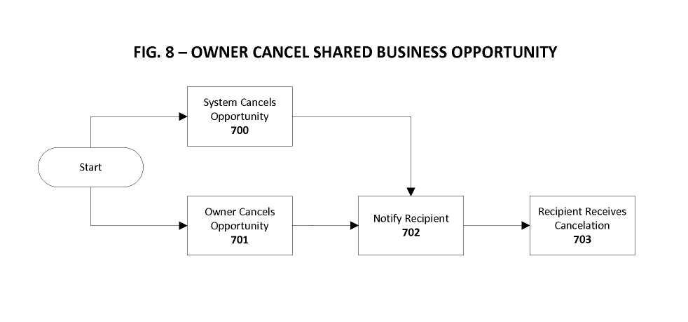

FIG. 8 shows a method for the system or an owner to cancel a business opportunity proposal 700-703. Typically, this is only triggered when contractual obligations are met (e.g., an expiry for specific performance lapsed and the opportunity needs to be canceled so it can be shared with another Recipient).

The System may automatically cancel a Finalized business opportunity 700 based on criteria in the Proposal such as expiry. The Owner may cancel a Finalized business opportunity 701 based on criteria in the Proposal such as expiry. Typically, the automated method is preferred but can be set to manual where manual intervention is required.

When cancelled, the Recipient is notified 702 using communication methods including, but not limited to, email, SMS, telephone, business network, or social network, and the Recipient receives the cancelation 703. The cancelation may optionally include a reason for cancelation.

Enhancements of the Present Invention

The Proposals in FIG. 3 201, FIG. 4 301, FIG. 5 401 & FIG. 6 501 may be created as a Standing Agreement between an Owner and a Recipient to simplify offers and negotiations. A Standing Agreement is a pre-defined Proposal that includes the information of a regular Proposal and information that limits the scope of the Standing Agreement such as Expiry, Location, etc.

The Proposals in FIG. 3 201, FIG. 4 301, FIG. 5 401 & FIG. 6 501 may be advertised as an open invitation to treat, invitation to bargain or invitation to offer as a method of soliciting others to capture business opportunities for the Owner. This may be performed as an agent of the Owner or as an independent Owner that automatically shares a Business Opportunity using a Standing Agreement to specific Recipients.

Any successful Recipient of a Business Opportunity, may in turn share the Business Opportunity with other Recipients. For clarity, the Recipient becomes the Owner and the process is repeated. When this occurs, any methods of Assessment or Feedback are passed through the entire chain of relationships (e.g., Customer Feedback is passed to the Recipient, the Recipient Owner and the original Owner).

The methods of offering and negotiating business opportunities with a single or a plurality of entities FIG. 3, FIG. 4, FIG. 5, and FIG. 6 can be fully automated using Proposal limits rather than specific values (e.g., minimum or maximum to create a range of numbers, dates and times, or other boundaries). The effect of this would be to create an automatic system of negotiations between an Owner and Recipients.

In all embodiments, a Proposal can request and track payments for a business opportunity. Those payments may be linked to specific milestones, such as when a business opportunity is first shared, when an opportunity is completed or canceled, or any other event agreed to by an Owner and Recipient.

In all embodiments, a Proposal can and will expire after some period of time causing the System to automatically cancel Proposals, leaving the Owner with the ability to create new Proposals.

Although the present invention has been described in terms of various embodiments, it is not intended that the invention be limited to these embodiments. Modification within the spirit of the invention will be apparent to those skilled in the art.

I claim:

1. A method comprising:
capturing at least one opportunity that includes a customer and customer metadata;
creating at least one proposal that includes said opportunity and terms of sale for said opportunity;
identifying at least one potential buyer;
offering said proposal to at least one potential buyer; and
storing records and relationships in a computer.

2. A method according to claim 1 further comprising:
identifying at least one potential buyer that was unconsidered by the owner of said opportunity at the time said opportunity was captured.

3. A method according to claim 1 further comprising:
negotiating said terms of said proposal for said opportunity.

4. A method according to claim 1 further comprising:
creating a standing agreement of terms with at least one potential buyer for at least one current or future proposal.

5. A method according to claim 1 further comprising:
requesting feedback from said buyer that purchased said opportunity regarding said opportunity.

6. A method according to claim 1 further comprising:
requesting feedback from said customer identified by said opportunity regarding said buyer.

7. A method according to claim 1 further comprising:
accepting said proposal by said buyer; and
requesting payment from said buyer at completion of at least one agreed milestone in said proposal, or
requesting payment from said buyer at completion of said opportunity.

8. A non-transitory computer-readable medium including one or more sequences of instructions which, when executed by one or more processors, cause:
capturing at least one opportunity that includes a customer and customer metadata;
creating at least one proposal that includes said opportunity and terms of sale for said opportunity;
identifying at least one potential buyer; and
offering said proposal to at least one potential buyer.

9. The non-transitory computer-readable medium of claim 8, wherein the instructions cause:
identifying at least one potential buyer that was unconsidered by the owner of said opportunity at the time said opportunity was captured.

10. The non-transitory computer-readable medium of claim 8, wherein the instructions cause:
negotiating said terms of said proposal for said opportunity.

11. The non-transitory computer-readable medium of claim 8, wherein the instructions cause:
creating a standing agreement of terms with at least one potential buyer for at least one current or future proposal.

12. The non-transitory computer-readable medium of claim 8, wherein the instructions cause:
requesting feedback from said buyer that purchased said opportunity regarding said opportunity.

13. The non-transitory computer-readable medium of claim 8, wherein the instructions cause:
requesting feedback from said customer identified by said opportunity regarding said buyer.

14. The non-transitory computer-readable medium of claim 8, wherein the instructions cause:
accepting said proposal by said buyer; and
requesting payment from said buyer at completion of at least one agreed milestone in said proposal, or
requesting payment from said buyer at completion of said opportunity.

15. A system comprising:
one or more processors; and
a non-transitory computer-readable medium including one or more sequences of instructions which, when executed by one or more processors, cause:
capturing at least one opportunity that includes a customer and customer metadata;
creating at least one proposal that includes said opportunity and terms of sale for said opportunity;
identifying at least one potential buyer; and
offering said proposal to at least one potential buyer.

16. The system of claim 15, wherein the instructions cause:
identifying at least one potential buyer that was unconsidered by the owner of said opportunity at the time said opportunity was captured.

17. The system of claim 15, wherein the instructions cause:
negotiating said terms of said proposal for said opportunity.

18. The system of claim 15, wherein the instructions cause:
creating a standing agreement of terms with at least one potential buyer for at least one current or future proposal.

19. The system of claim 15, wherein the instructions cause:
requesting feedback from said buyer that purchased said opportunity regarding said opportunity.

20. The system of claim 15, wherein the instructions cause:
requesting feedback from said customer identified by said opportunity regarding said buyer.

21. The system of claim 15, wherein the instructions cause:
accepting said proposal by said buyer; and
requesting payment from said buyer at completion of at least one agreed milestone in said proposal, or
requesting payment from said buyer at completion of said opportunity.
